(19) United States
(12) Patent Application Publication
(10) Pub. No.: US 2025/0335560 A1
(43) Pub. Date: Oct. 30, 2025

(54) LOGICAL AUTOMATED SYSTEMATIC SIFTING OF AIS

(71) Applicant: Deep Detection LLC, Troy, NY (US)

(72) Inventors: Alexander Bringsjord, Rensselaer, NY (US); Selmer Bringsjord, Rensselaer, NY (US); Naveen Sundar Govindarajulu, Rensselaer, NY (US)

(21) Appl. No.: 19/188,463

(22) Filed: Apr. 24, 2025

Related U.S. Application Data
(60) Provisional application No. 63/637,954, filed on Apr. 24, 2024.

(51) Int. Cl. G06F 21/31

(52) U.S. Cl. CPC G06F 21/31; G06F 2221/2103

(57) ABSTRACT

A logic based sifting system and method. A system includes: a memory and processor configured to control access to a resource according to a process that includes: generating a logic problem; displaying a logic based story based on the logic problem; displaying at least one question relating to the story; and controlling access to the resource based on a received response to the at least one question.

### PRIORITY CLAIM

This application claims priority to copending provisional application Ser. No. 63/637,954, entitled, LOGICAL AUTOMATED SYSTEMATIC SIFTING OF AIS, filed on Apr. 24, 2024.

### BACKGROUND

### 1. Technical Field

This invention relates generally to online security and more particularly to a system for automated sifting of artificial intelligent agents (AI's) using logics.

### 2. Related Art

Online security often includes challenge and response tests and tools such as Captcha to ensure a human is responding and to sift out artificial intelligent agents (AI's), e.g., bots and the like, to deter attacks and spam. Unfortunately, new technologies such generative AI and the like are now capable of defeating such tools.

### SUMMARY

The present invention provides enhanced challenge and response systems and methods for sifting AIs. One aspect generates visual or textual logic problems that require a proof to solve, e.g., in the form of questions.

One aspect includes a logic based sifting system, comprising: a memory and processor configured to control access to a resource according to a process that includes: generating a logic problem; displaying a logic based story based on the logic problem; displaying at least one question relating to the story; and controlling access to the resource based on a received response to the at least one question.

A further aspect includes a computing method to control access to a resource, comprising: generating a logic problem; displaying a logic based story based on the logic problem; displaying at least one question relating to the story; and controlling access to the resource based on a received response to the at least one question.

### BRIEF DESCRIPTION OF THE DRAWINGS

FIG. 1 depicts an online access point that utilizes a logic based sifting system in accordance with an embodiment of the invention.

FIG. 2 depicts a method of a logic based sifting system in accordance with an embodiment of the invention.

FIG. 3 depicts an example of a logic based story according to illustrative embodiments.

FIG. 4 depicts a further example of a logic based story according to illustrative embodiments.

FIG. 5 depicts a hypergraphical interface displaying a logic problem according to illustrative embodiments.

FIG. 6 depicts a hypergraphical interface displaying a solution according to illustrative embodiments.

FIG. 7 depicts an implementation embodiment according to illustrative embodiments.

FIG. 8 depicts a further implementation embodiment according to illustrative embodiments.

FIG. 9 depicts a further implementation embodiment according to illustrative embodiments.

FIG. 10 depicts a computer system configured to run the logic based sifting system in accordance with an embodiment of the invention.

### DETAILED DESCRIPTION

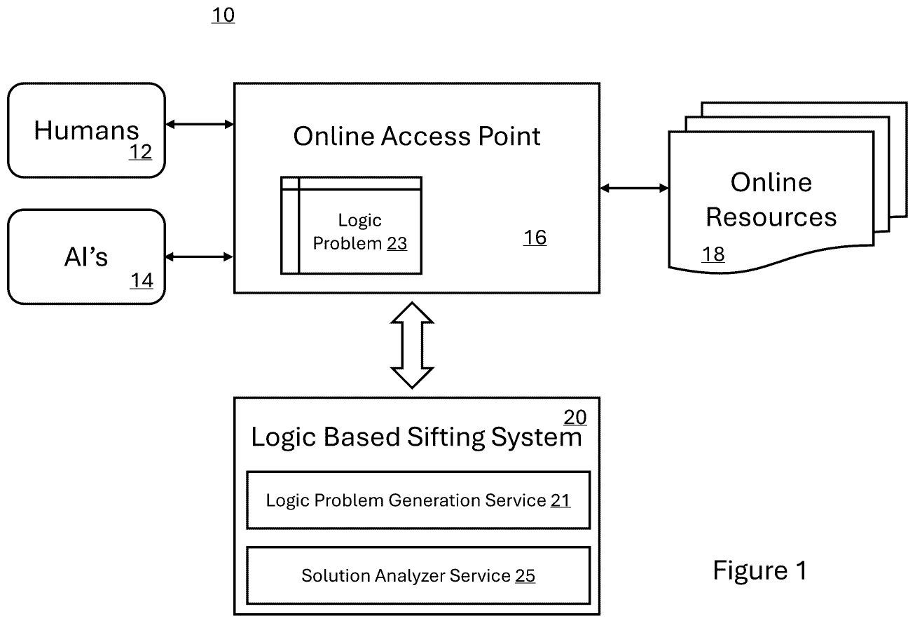

Referring now to the drawings, FIG. 1 depicts a computing architecture 10 having an online access point 12 that utilizes a logic based sifting system 20 to distinguish humans 12 from artificial intelligent agents (AI's) to access online resources 18. AI's may comprise any type of non-human agents, e.g., a machine learning systems, a software agent, a bot, an AI system, etc. Using this approach, logic based sifting system 20 includes a logic problem generation service 21 that generates a logic problem 23. If the actor (i.e., human) responds correctly to the logic problem 23, they are granted access to the online resources 18. If they do not respond correctly, they are denied access. Resources 18 may comprise any type of system, device, program, gateway, account, etc.

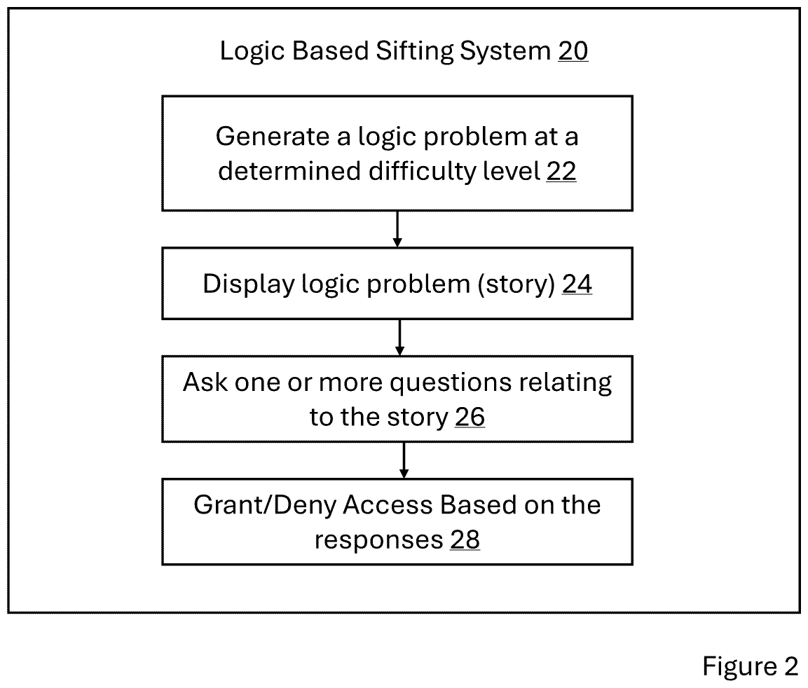

FIG. 2 depicts a method of the logic based sifting system 20 with an embedded process for granting or denying access to a resource. First, a logic problem 23 is generated at a determined difficulty level 22. In certain embodiments, the problem is presented as a logic based story and questions/responses. The level of difficulty can be determined in any manner, e.g., based on the type of resources being sought, based on the type of user, etc. Next, the logic problem 23 (i.e., “story”) at the prescribed difficulty level is displayed for the user 24. The process then asks one or more questions to the user about the story 26. Based on the responses from the user, they are granted or denied access 28 to the resource.

The problem/story can be presented in any form, e.g., audible, graphical, tactile and/or textual. In certain embodiments, a story is generated from a logic problem using image based generative AI. Illustrative graphical representations may include a grid or image on which object are arranged, a puzzle, a video game, etc. The questions and responses require the user to use reasoning (e.g., using theorems, proofs, etc.). For example, the questions may involve spatial or other relationships of the objects. Such an approach is beyond the capabilities of generative AI, which relies on models to predict outputs. U.S. Pat. No. 11,526,779, “Artificial Intelligence Platform for Auto-Generating Reasoning Problems and Assessing Solutions,” Bringsjord et al., and U.S. Pat. No. 11,379,732, “Counter Fraud System” issued on Jul. 5, 2022, which are hereby incorporated by reference and that detail approaches for generating reasoning problems that can be applied to the current system. In such an approach, problems are generated dynamically when a user requests access to a resource. In alternative approaches, the problems can be generated ahead of time and securely stored.

The present approaches provide a technological improvement over prior technologies, such as CAPTCHA, which challenge the user to select pictures that contain a feature. These prior technologies constitute a very “low bar,” because increasingly AIs can crack these challenges. Instead, the present approach utilizes the concept of deep sifting, which sifts out AIs from humans by presenting much more difficult problems, namely logic problems, such as those described by U.S. Pat. No. 11,526,779. Using this approach, only humans will be able to gain access; AIs will be blocked.

There are a host of theorems that determine how difficult a generated logic problem is, ranging from those requiring exponential time to solve (on the size of the inputs), to those that are semi-solvable, to fully unsolvable in the general case. To use some of the mathematical terminology, problems in the first category could be co-NP-complete (e.g., problems that ask whether an “English-clothed” statement at the level of the propositional calculus is a tautology). Problems in the second category could ask whether an “English-clothed” statement at the level of first-order logic follows deductively from another such statement. The next category would be problems at the level of full second-order logic. In the proposed method, all individual cases presented to users attempting to gain access are pre solved by the method, after they have been generated.

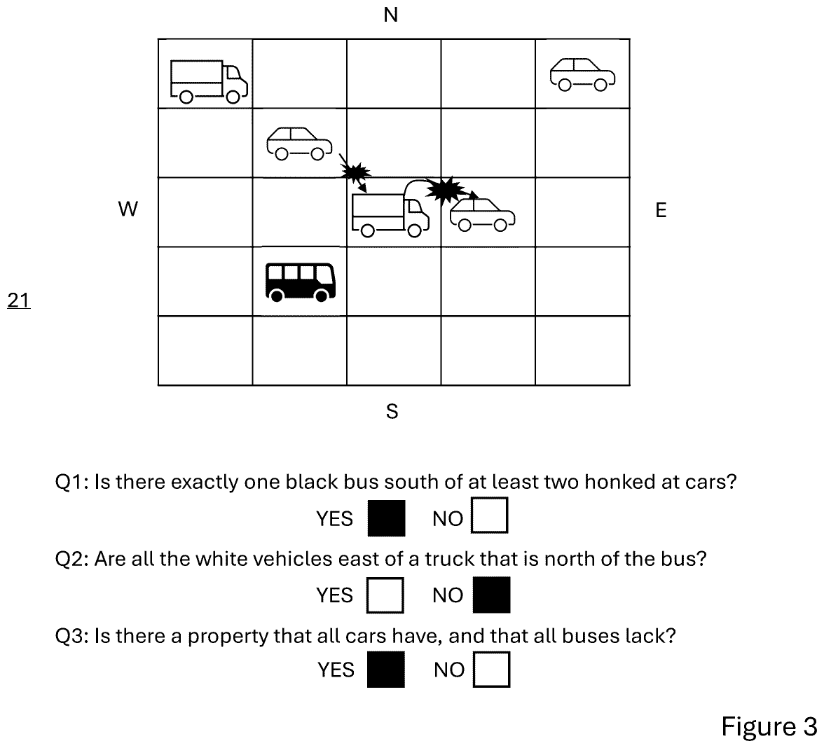

FIG. 3 depicts an illustrative logic problem 21 with a story generated on a grid, and a series of yes/no questions. When a user (human or AI agent) seeks access to a resource, a problem such as this is generated. In this case, the problem's story is in the form of an annotated diagram, and three stems/questions are issued, in this case having two options (YES and NO). In this example, the user did not answer all the questions correctly, so access would be denied. Q1's key is NO, because there is only one honked-at car, which was answered incorrectly. Q2's key is NO as is shown here (not all white vehicles are east of the truck). Q3's key is YES because, e.g., all cars are white, and all buses black. Hence, access is denied.

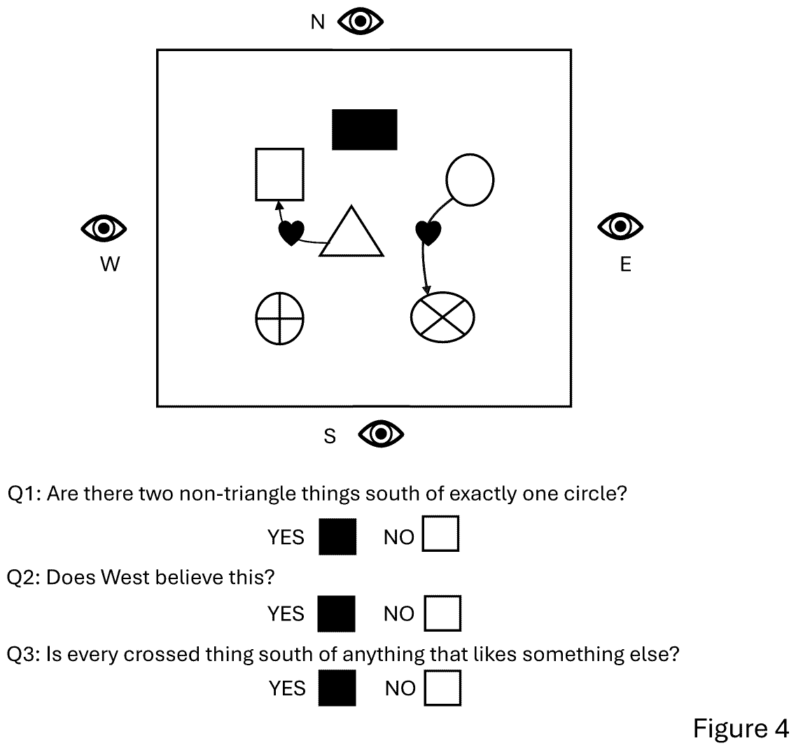

FIG. 4 depicts a further illustrative logic problem 21 with a story generated in space, and a series of yes/no questions. In this case, there are four viewers as well (N,S,E,W). Question 1 is correctly answered, there are two non-triangle things south of exactly one circle. Question 2 is likewise answered correctly, W would believe this, since from their view point, they can gauge north and south. Question 3 is likewise answered correctly as every crossed thing is south of something that like something. Accordingly, access would be granted. In a more difficult problem, the user might be asked to prove that question 2 is yes, e.g., using a hypergraphical interface.

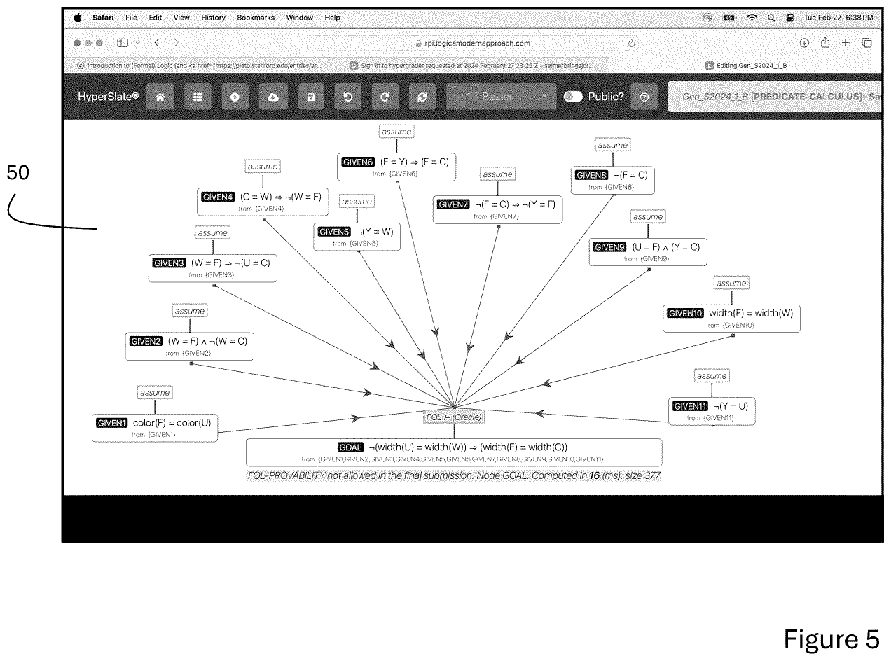

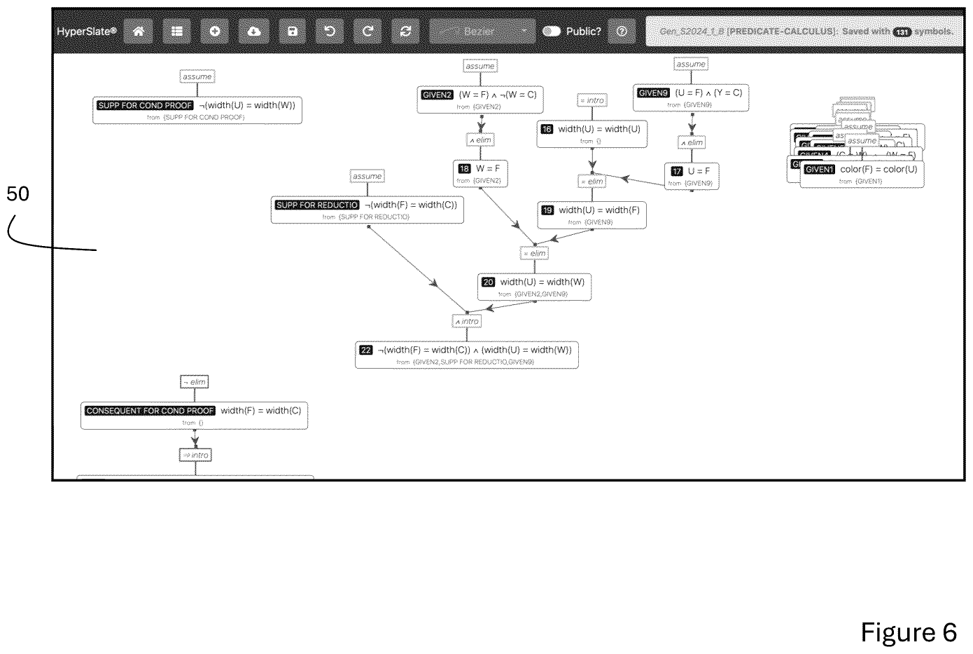

An example of a hypergraphical interface 50 (Hyperslate®) is shown in FIG. 5, which uses a hypergraph (e.g., nodes and arcs) to present the following logic problem presented to a user. A parking lot currently contains seven vehicles. The lot is managed by a group of valets who park the vehicles, and drive them back to their owners. The valets put at least one label, an upper-case Roman letter on a small card, under a windshield wiper of every car they park. Sometimes they stupidly put more than one label under the same wiper (which is the reason for the phrase “at least” in the previous sentence). Fortunately, there are no duplicate labels/cards: all the valets use a fixed set of 26 cards. The user is supplied with 11 given statements from which you must prove in the hypergraphical interface 50 (i.e., HyperSlate) that if the width of a vehicle labeled U is not the same as the width of a vehicle labeled W, then the width of the vehicle labeled F is the same as the width of the vehicle labeled C. FIG. 6 depicts the correct proof provided by a user, created within the hypergraphical interface 50. HyperSlate is an example of a hypergraphical system for building proofs, arguments, and programs (the latter in the new programming language Hyperlog®), in collaboration with AI. The system has built-in automated reasoners that can be enlisted to automatically solve sub-problems, and join humans in the search for full solutions. These concepts are also described in further detail in U.S. patent application Ser. No. 18/752,122 filed on Jun. 24, 2024 entitled 3D/4D AI-INFUSED REASONING AND LOGIC PROGRAMMING PLATFORM, the contents of which are hereby incorporated by reference.

Within interface 50, the user is able to access a hypergraph editor to create and edit solutions including constructing nodes, arcs (i.e., arrows) for connecting nodes. The system may also be used for autogenerating solutions or partial solutions, etc. The user is also able to interact with hypergraph viewing tools, which for example allows the user to navigate and interact with hypergraphs. Once a hypergraph is created, solutions can be evaluated. In certain embodiments, automated reasoning may be implemented to allow the system to automatically create logic problems and evaluate solutions.

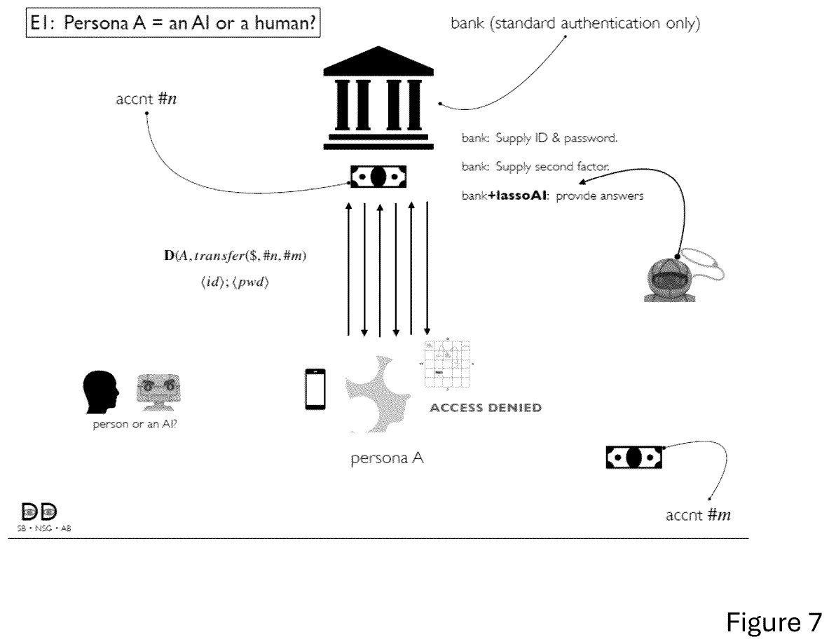

FIG. 7 depicts an example implementation of logic based sifting system 20. The bank in this example holds funds in account #n, and a persona A communicates a desire to transfer a large sum of money from this account to another, account #m, in another bank. The term persona as used in this example is the collection of pieces of information presented as purportedly emanating from and corresponding to the underlying “ground-truth” agent (natural/human or artificial/AI). The bank here relies first on standard protocols, and asks that an ID and password be supplied, and then after that issues a request for a second factor (e.g., the return of a code sent to the mobile smartphone registered as persona A's). After this step, our “logicist automated systematic sifting of prohibitive agents (LA SSO-PA) is engaged (as shown depicted here by the small grid on the right of the image of persona A), and the associated requirement is issued to persona A. It is impossible for this requirement to be met by an AI. In the case depicted here, persona A corresponds to an AI, not a human; here ACCESS DENIED. Note that authentication often needs to be provided beyond just at the individual level. The persona presenting for verification can correspond to a group of agents (e.g. humans, a household, or a firm).

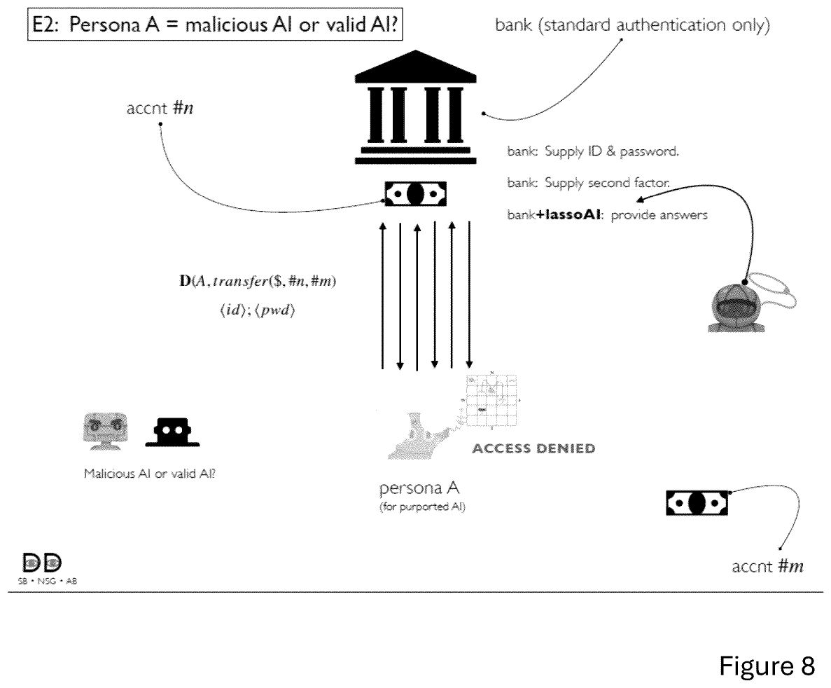

FIG. 8 depicts a further example. In certain cases in today's world, it may be necessary to verify that certain AI agents are not malicious, and can therefore be granted access to whatever content/resources/funds is being requested. E.g., a wealth management firm might have an AI that logs into various banking systems, or information system (IS) portals. The example in FIG. 8 is based upon just such a situation. In this case, persona A is the representation of an AI. The overall protocol and use of LASSO-PAs here is structurally the same as the example above, however, importantly, the problem that must be solved in order to be authenticated and gain access is (obviously) solvable by artificial agents in general, but not by any of those who qualify to gain access here.

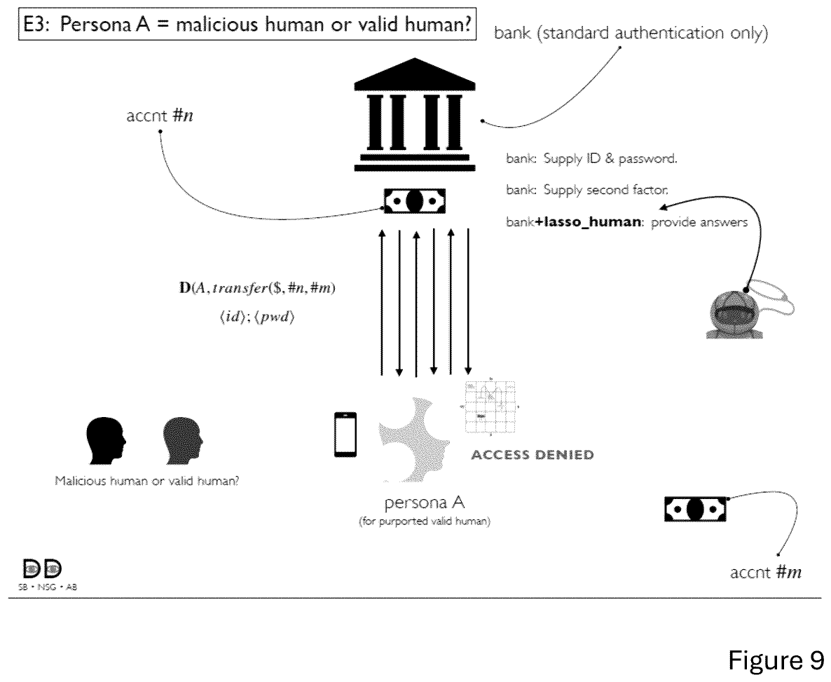

FIG. 9 depicts a further example. Here, authentication is of a human, the correct/valid one from among other humans who may be seeking access, maliciously. It is noted that embodiments as are given herein can be layered. E.g., this can be viewed as being triggered once all AIs have been excluded, and then the sifting process moves to what is shown in FIG. 9. The problem required by LASSO-PAs to be solved is one that can be solved only by humans, and only by humans with particular knowledge possessed by the correct/valid human. Such knowledge far exceeds a tidbit such as is customarily provided by a code is sent to a mobile phone. Any such code, in general any such piece of information sent out by bank (or whatever counterpart organization seeks to regulate access) can in principle be obtained during transit, and is thus intrinsically untrustworthy to an appreciable degree. In the case at hand here, persona A must be able to solve a problem that can be solved only by an agent with knowledge arising from the local environment of persona A, or the cognitive etiology of an authentic, valid human.

In various embodiments, the logic problems 23 generated in logic based sifting system 20 are done automatically by an AI platform, such as that described in U.S. Pat. No. 11,526,779. The logic problems in question are solved by providing either a suitable proof or set of proofs, a formal argument (a formal argument is one composed of a series of inferences that conform, or at least intended to conform, to a collection of inference rules), or a computer program given in a pure, general form of what is known as “logic programming.” In addition to generating logic problems, logic based sifting system 20 also includes a solution analyzer service 25 that can check and either validate or reject the user's response. HyperGrader is an illustrative system capable of generating logic problems and analyzing solutions. Generated problems can be presented in one or more natural languages with enough variation to make it seem as though the text was generated by a human. The text can also be personalized, and may have automatically generated images and videos that describe the problem.

Problem generation may utilize one or more logics (i.e., logical systems) that include a defined symbol set and grammar. Logic is a type of formal system that uses symbol sets (sometimes referred to as an alphabet) to finitely construct a formal language from a set of axioms through inferential rules of formation. Logic is a formal system together with a form of semantics, usually in the form of model-theoretic interpretation, which assigns truth values to sentences of the formal language, that is, formulae that contain no free variables. A logic is sound if all sentences that can be derived are true in the interpretation, and complete if, conversely, all true sentences can be derived. Logics may include, e.g., game theory, calculus, algebra, geometry, ethics, etc. Symbol sets generally comprise relations (e.g., tall, short, above, between, etc.), functions (+, −, etc.) and operators. Grammar is the set of rules for how strings of symbols can be composed into formulas. For example, in an animal domain where x is variable in this example defined as a kangaroo, [symbol] x(Tall(x)→Smart(x)) comprises a logic formula that represents the statement “all tall kangaroos are smart.” For a given logic/domain, a set of formulas is first generated.

Once the set of formulas is defined, the dynamic process of generating a new problem first begins with the selection of a problem TY PE and difficulty level. A first TYPE of problem is of the form:
Given formula 1
Given formula 2
Given Formula 3
Goal

For example, consider the following problem: a triangle T as two interior angles that sum to 100 degrees (formula 1), so its third angle equals 80 degrees (formula 2), prove it (goal). Other TYPES of problems may be of the form “P or not P”; Axioms/Lemmas/Givens; Is it a theorem or a falsehood?; etc.

Next, the system generates a candidate set of problems of the selected type/difficulty with the established formulas, using a random (or semi-random) process. A determination is made whether a solution (i.e., proof) exists for each generated problem. Most candidate problems will likely not have a solution. Accordingly, if a problem does not have a solution, the next candidate problem is checked, and so on until a problem is identified that has a solution. Determining whether a solution exists may be handled in any manner (e.g., using a checker). Once a problem is identified having a solution, a check is then made at to determine if the solution has the right complexity. Formal reasoning problems, and pure logic programming problems, can be translated into a hypergraphical format, and presented as such.

The present invention may be a system, a method, and/or a computer program product. The computer program product may include a computer readable storage medium (or media) having computer readable program instructions thereon for causing a processor to carry out aspects of the present invention.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

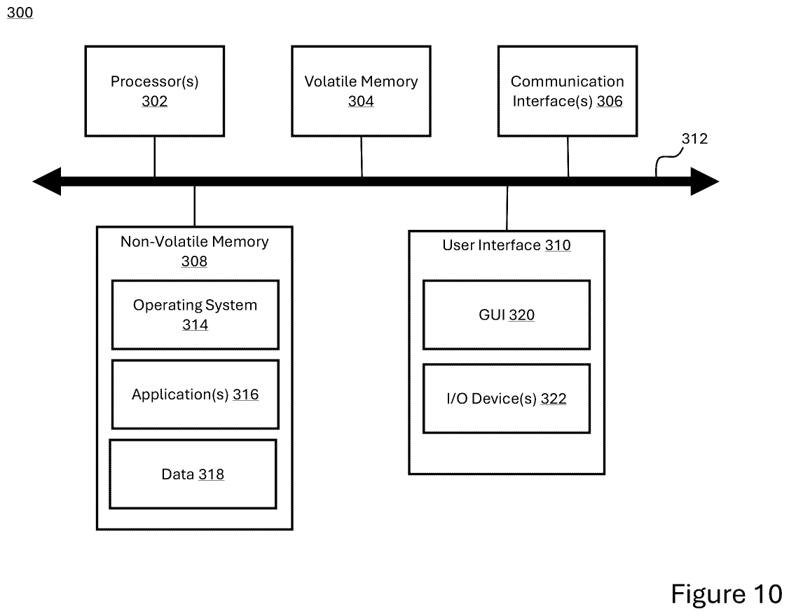

FIG. 10 depicts an illustrative computer system that may comprise any type of computing device and, and for example includes at least one processor, memory, an input/output (I/O) (e.g., one or more I/O interfaces and/or devices), and a communications pathway. In general, processor(s) execute program code, such as logic based sifting system, which is at least partially fixed in memory. While executing program code, processor(s) can process data, which can result in reading and/or writing transformed data from/to memory and/or I/O for further processing. Pathway provides a communications link between each of the components in computer system. I/O can comprise one or more human I/O devices, which enable a user to interact with computer system. To this extent, logic based sifting system can manage a set of interfaces (e.g., graphical user interfaces, application program interfaces, etc.) that enable humans and/or other systems to interact with the computer system or access point.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A logic based sifting system, comprising:
a memory and processor configured to control access to a resource according to a process that includes:
generating a logic problem;
displaying a logic based story based on the logic problem;
displaying at least one question relating to the story; and
controlling access to the resource based on a received response to the at least one question.

2. The logic based sifting system of claim 1, wherein the logic problem is generated using:
symbol sets that define relations, functions, and operators; and
grammar that provides rules for how strings of symbols can be composed into formulas.

3. The logic based sifting system of claim 2, wherein the logic based story comprises an image having a set of objects.

4. The logic based sifting system of claim 3, wherein the at least one question includes a plurality of questions directed to the spatial relationship of the objects.

5. The logic based sifting system of claim 2, wherein generating the logic problem includes:
generating a plurality of candidate logic problems; and
using a solution analyzer to determine whether each of the plurality of candidate logic problems includes a viable solution.

6. The logic based sifting system of claim 5, wherein controlling access based on received responses to the at least one question includes using the solution analyzer to analyze received responses.

7. The logic based sifting system of claim 2, wherein the logic problem comprises a unique logic problem.

8. The logic based sifting system of claim 2, wherein the logic based story is presented as a hypergraph.

9. The logic based sifting system of claim 8, wherein the at least one question includes a request for a proof.

10. The logic based sifting system of claim 9, wherein the request for the proof includes a request for a hypergraphical proof.

11. A computing method to control access to a resource, comprising:
generating a logic problem;
displaying a logic based story based on the logic problem;
displaying at least one question relating to the story; and
controlling access to the resource based on a received response to the at least one question.

12. The method of claim 11, wherein the logic problem is generated using:
symbol sets that define relations, functions, and operators; and
grammar that provides rules for how strings of symbols can be composed into formulas.

13. The method of claim 12, wherein the logic based story comprises an image having a set of objects.

14. The method of claim 13, wherein the at least one question includes a plurality of questions directed to the spatial relationship of the objects.

15. The method of claim 12, wherein generating the logic problem includes:
generating a plurality of candidate logic problems; and
using a solution analyzer to determine whether each of the plurality of candidate logic problems includes a viable solution.

16. The method of claim 15, wherein controlling access based on received responses to the at least one question includes using the solution analyzer to analyze received responses.

17. The method of claim 12, wherein the logic problem comprises a unique logic problem.

18. The method of claim 12, wherein the logic based story is presented as a hypergraph.

19. The method of claim 18, wherein the at least one question includes a request for a proof.

20. The method of claim 19, wherein the request for the proof includes a request for a hypergraphical proof.
